(19) United States
(12) Patent Application Publication
(10) Pub. No.: US 2017/0027118 A1
(43) Pub. Date: Feb. 2, 2017

(54) Avocado Seed Planter

(71) Applicant: Kathryn Ora Mahler, Lawrenceville, GA (US)

(72) Inventor: Kathryn Ora Mahler, Lawrenceville, GA (US)

(21) Appl. No.: 14/811,628

(22) Filed: Jul. 28, 2015

(51) Int. Cl. A01G 31/02

(52) U.S. Cl. CPC A01G 31/02

(57) ABSTRACT

The Avocado Seed Planter is a reusable device which holds an avocado seed while it produces roots in a jar or glass of water.

Once the seed has rooted it is removed from the planter and can be planted in a pot with dirt to grow as a house plant or planted to grow outside if desired. At which time the planter can be reused with another seed.

### BACKGROUND OF THE INVENTION

Description

The Avocado Seed Planter is a reusable device which supports an avocado seed while it roots in a jar or glass of water.

Once the seed has rooted it can be planted in a pot with dirt to grow as a house plant or planted to grow outside if desired. At which time the planter can be reused with another seed.

Prior Art

It is common to root the Avocado seed in water by taking toothpicks and sticking them into the seed. The toothpicks are spaced evenly to balance the seed over the rim of a glass filled with water where only the lower third to one half of the seed is in the water. However, this causes a risk of damage or infection to the plant. Toothpicks can also break and it can be messy.

### SUMMARY

### Drawings Explanation

FIG. 1 View of the planter not in use with parts detailed by numbers.

FIG. 2 View of the planter in a glass filled with water and parts not detailed in FIG. 1 are detailed by numbers.

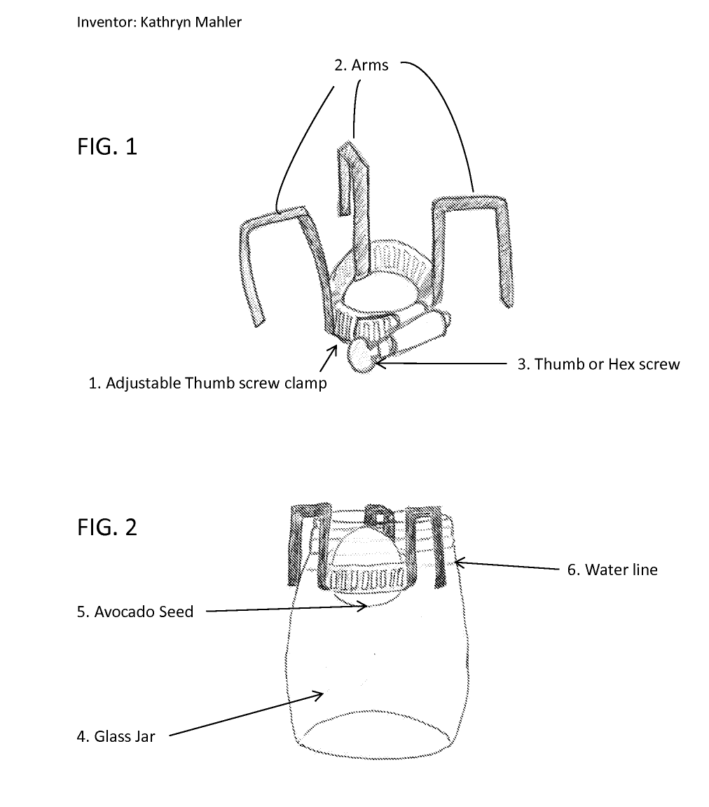

The planter (FIG. 1); is made with a round adjustable, thumb-screwed or screwed stainless steel clamp to hold the seed and three bendable aluminum arms which hang over the glass. The center is made from an adjustable clamp #1, the clamp holds the Avocado seed #5 in place while the attachment of the arms #2 are spaced (fixed and not adjustable) to balance and keep the seed in place until it roots and leaves sprout. The arms also keep the planter balanced on the rim of the glass (FIG. 2). The bottom of the seed stays wet and the top dry when inserted into the glass of water#4 filled just enough to cover the bottom of the seed. #6

The adjustable clamp allows for different seed sizes and the adjustable arms allow for different sized glass or jar. The seed will expand as it starts to sprout; the adjustments can be made as needed with the thumb screw #3 on the clamp. The arms are adjustable by straightening and then bending to the desired size to fit the glass.

Other models will be larger for other seeds or plants that can also be root started in water as well.

Some devices will be decorated on the arms with embellishments. (Not Shown)

They will be available in different colors. The paint used on some is rubber paint to help prevent the device from rusting in the event it's kept in the water for prolonged periods of time.

I do not claim the invention or design of the thumbscrew or screwed adjustable clamp.

I claim:

1. To have created a reusable device that supports an Avocado seed while rooting in water.

2. To have created an adjustable device that supports an Avocado seed while rooting in water.
